(19) United States
(12) Patent Application Publication
(10) Pub. No.: US 2026/0265580 A1
(43) Pub. Date: Sep. 10, 2026

(54) STRUCTURE SHEET

(71) Applicant: KEIWA Incorporated, Tokyo (JP)

(72) Inventors: Toshikatsu FURUNAGA, Tokyo (JP); Yoshiki NAKAJIMA, Tokyo (JP); Noriaki OTANI, Tokyo (JP); Yuki MATSUNO, Tokyo (JP); Koji TERAMOTO, Tokyo (JP); Tatsunori KITAZATO, Tokyo (JP); Yasuo NISHIMURA, Tokyo (JP); Akira NINOMIYA, Tokyo (JP)

(73) Assignee: KEIWA Incorporated, Tokyo (JP)

(21) Appl. No.: 18/871,757

(22) PCT Filed: Jun. 2, 2023
(86) PCT No.: PCT/JP2023/020687

§ 371 Date: Dec. 4, 2024

(30) Foreign Application Priority Data
Jun. 6, 2022 (JP) 2022-091700
Jun. 2, 2023 (JP) 2023-091408

(51) Int. Cl. C09J 7/21; E04G 23/02

(52) U.S. Cl. CPC C09J 7/21; E04G 23/0281; C09J 2301/312; C09J 2301/50; C09J 2400/10; C09J 2400/22; C09J 2400/26

(57) ABSTRACT

A structure sheet 2 includes a functional layer 4, an intermediate layer 6, an adhesive layer 8, and a reinforcing body 10. The reinforcing body 10 is embedded in the intermediate layer 6. The reinforcing body 10 is preferably a fabric. The material of the fabric is typically a synthetic resin composition. The fabric has a tensile strength of 5.0 MPa or more and an elongation of 15.0% or less, as measured in a tensile test. The material of the intermediate layer 6 is preferably a composite material containing a polymer and cement.

### TECHNICAL FIELD

The present specification discloses a sheet that is used by being adhered to a structure.

### BACKGROUND ART

When a roof made of artificial slate is exposed to rain and wind for an extended period, deterioration occurs. Rain may leak through a roof that has deteriorated. Artificial slate is coated with a coating material with the aim of preventing rain leakage. When an artificial slate roof is severely deteriorated, however, rain leakage may not be prevented even by coating the roof with a coating material.

WO 2021/010456 discloses a sheet having a polymer cement layer and a resin layer. By adhering this sheet to a roof, rain leakage through the roof can be suppressed.

### CITATION LIST

### Patent Literature

[PTL 1] WO 2021/010456

### SUMMARY OF INVENTION

### Technical Problem

The sheet is adhered to the roof while a worker applies tension thereto. Due to this tension, the sheet may stretch. Excessive stretching makes it difficult for the worker to position the sheet. The sheet may also be damaged by the stretching. The worker must handle the sheet carefully in order to avoid damage. The sheet disclosed in WO 2021/010456 is not easy to handle. A sheet with a superior handling property is desirable.

There is also demand for a sheet with a superior handling property when repairing roofs other than artificial slate roofs. There is also demand for a sheet with a superior handling property when repairing or reinforcing structures other than roofs.

An object of the present applicant is to provide a structure sheet with a superior handling property.

### Solution to Problem

A structure sheet disclosed in the present specification includes a functional layer, an adhesive layer, and a reinforcing body.

### Advantageous Effects of Invention

The structure sheet includes the reinforcing body and is therefore less likely to stretch and less likely to be damaged when tension is applied. The structure sheet thus has a superior handling property.

### BRIEF DESCRIPTION OF DRAWINGS

FIG. 1 is a perspective view showing a part of a structure sheet according to an embodiment.

FIG. 2 is a sectional view along a II-II line in FIG. 1.

FIG. 3 is an enlarged view showing a part indicated by a symbol III in FIG. 2.

FIG. 4 is a front view showing the structure sheet of FIG. 1 together with a roof.

FIG. 5 is an enlarged view showing a part indicated by a symbol V in FIG. 4.

FIG. 6 is an enlarged view showing a part indicated by a symbol VI in FIG. 4.

FIG. 7 is an enlarged plan view showing a part of a reinforcing body included in the structure sheet of FIG. 1.

FIG. 8 is a sectional view showing a part of a structure sheet according to another embodiment.

### DESCRIPTION OF EMBODIMENTS

Preferred embodiments will be described in detail below with reference, as appropriate, to the figures.

### First Embodiment

### [Layer Structure]

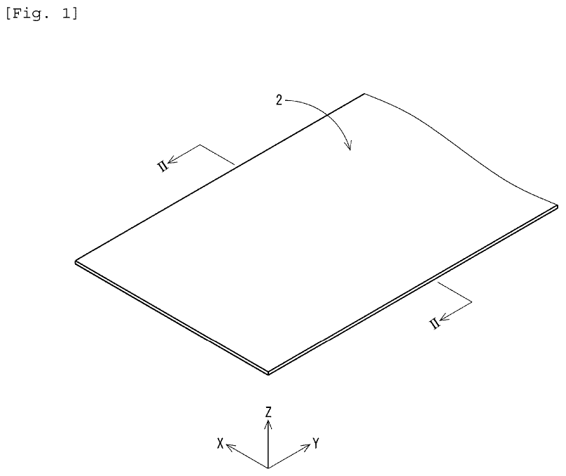

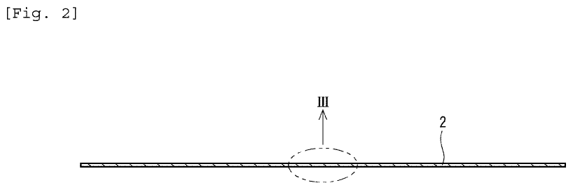

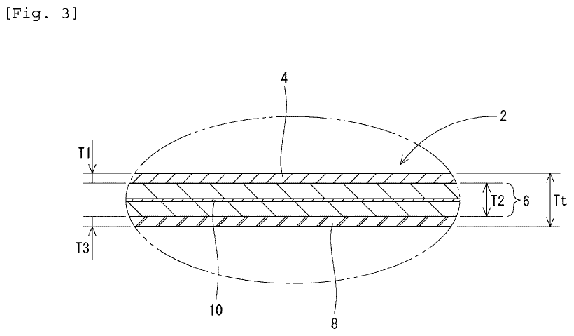

FIGS. 1 to 3 show a structure sheet 2. In FIG. 1, an arrow X represents a width direction of the sheet 2, an arrow Y represents a length direction of the sheet 2, and an arrow Z represents a thickness direction of the sheet 2. The sheet 2 has a substantially rectangular planar shape. As is evident from FIG. 3, the sheet 2 includes a functional layer 4, an intermediate layer 6, an adhesive layer 8, and a reinforcing body 10. The reinforcing body 10 is embedded in the intermediate layer 6. The materials and so on of each of the layers will be described in detail below. The sheet 2 is adhered to a structure. The sheet 2 may include a release sheet or a release film. The release sheet or release film is laminated onto the adhesive layer 8.

### [Roof Repair]

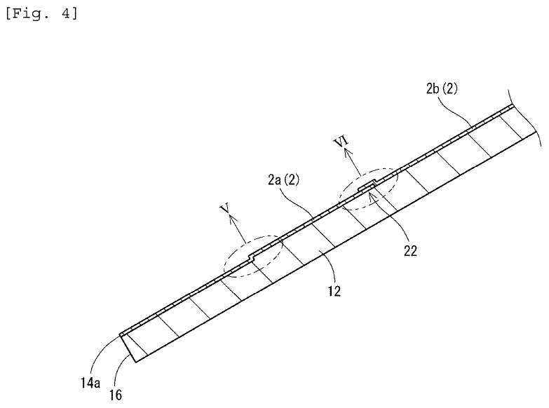

A typical application of the structure sheet 2 is repairing a roof 12. FIGS. 4 to 6 show the repaired roof 12. These figures show two sheets 2 (a first sheet 2a and a second sheet 2b) together with the roof 12. Specifications of the second sheet 2b are identical to specifications of the first sheet 2a. An artificial slate roof, a tiled roof, a steel sheet roof (including a folded plate roof), a copper plate roof, a galvanized iron roof, a concrete roof, and so on may be cited as the roof 12.

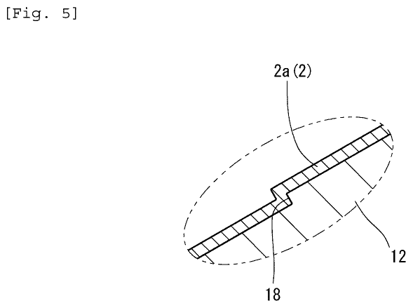

In FIG. 4, the position of a lower edge 14a of the first sheet 2a is substantially aligned with the position of a lower end 16 of the roof 12. The first sheet 2a is adhered as a whole to the roof 12. As shown in FIG. 5, the roof 12 includes a step 18. The first sheet 2a is bent in the vicinity of the step 18. As a result of this bend, the first sheet 2a conforms to the step 18.

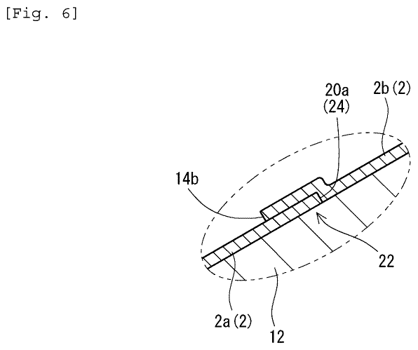

As shown in FIG. 6, the second sheet 2b overlaps the vicinity of an upper edge 20a of the first sheet 2a in the vicinity of a lower edge 14b thereof. Due to this overlap, a joint 22 is formed. The part of the second sheet 2b other than the joint 22 is adhered to the roof 12. The upper edge 20a of the first sheet 2a forms a step 24 between the first sheet 2a and the roof 12. The second sheet 2b is bent in the vicinity of the step 24. As a result of this bend, the second sheet 2b conforms to the step 24.

### [Primer Layer]

The structure sheet 2 is normally adhered to the roof 12 via a primer layer. In this specification, the wording “the sheet is adhered to the roof” also applies to a case in which the sheet 2 is adhered to the roof 12 via a primer layer or the like. The primer layer is not shown in FIGS. 5 and 6.

The material of the primer layer is preferably a curable resin composition. Curable resins include thermosetting resin and photosetting resin, for example. The curable resin is preferably an epoxy compound. Epoxy compounds include bisphenol A epoxy resin, bisphenol F epoxy resin, bisphenol S epoxy resin, ortho-Cresol novolac epoxy resin, alicyclic epoxy resin, aliphatic epoxy resin, a diglycidic ether of a phenol, and a diglycidic ether of an alcohol, for example.

Curing agents for the epoxy compound include polyfunctional phenols, amines, polyamines, mercaptans, imidazoles, acid anhydrides, and phosphorus-containing compounds, for example. Polyfunctional phenols include: hydroquinone, resorcinol, and catechol, which are monocyclic bifunctional phenols; bisphenol A, bisphenol F, naphthalenediols, biphenols, and halides thereof, which are polycyclic bifunctional phenols; and alkyl group substitutions, for example. Polyfunctional phenols also include novolac and resol, which are polycondensates of phenols and aldehydes, for example. Amines include: aliphatic or aromatic primary amines, secondary amines, tertiary amines, quaternary ammonium salts, and aliphatic cyclic amines; guanidines; and urea derivatives, for example.

A combination of a bisphenol A epoxy or bisphenol F epoxy base agent and a polyamine or mercaptan curing agent is particularly preferable. The primer layer containing epoxy resin may contain additives such as a coupling agent, a viscosity modifier, and a curing accelerator.

The primer layer can be formed by applying a solution or an emulsion containing the epoxy compound to the roof 12. Preferred emulsions include a two-component reactive curing water-based epoxy resin emulsion (product name “ARONBULLCOAT P-300”) manufactured by Toagosei Co., Ltd., for example.

The thickness of the primer layer in a wet state is preferably 50 to 300 μm inclusive. A primer layer having a thickness of 50 μm or more exhibits superior thickness uniformity. From this viewpoint, the thickness is more preferably 70 μm or more, and particularly preferably 80 μm or more. A primer layer having a thickness of 300 μm or less can suppress deviation of the structure sheet 2 from the roof 12. From this viewpoint, the thickness is more preferably 270 μm or less, and particularly preferably 250 μm or less.

### [Tensile Strength and Elongation of Sheet]

The tensile strength of the structure sheet 2 is preferably 5.0 MPa or more. When the tensile strength is 5.0 MPa or more, the sheet 2 is less likely to break when tension is applied thereto. The sheet 2 thus exhibits a superior handling property. From this viewpoint, the tensile strength is more preferably 5.6 MPa or more, and particularly preferably 6.0 MPa or more. From the viewpoint of conformability, the tensile strength is preferably 10.0 MPa or less, more preferably 9.5 MPa or less, and particularly preferably 9.0 MPa or less.

The elongation at break of the structure sheet 2 is preferably 15.0% or less. When the elongation is 15.0% or less, the sheet 2 is less likely to deform when tension is applied thereto. The sheet 2 thus exhibits a superior handling property. From this viewpoint, the elongation is more preferably 13.0% or less, and particularly preferably 11.0% or less. From the viewpoint of conformability, the elongation is preferably 5.0% or more, more preferably 7.0% or more, and particularly preferably 8.5% or more.

In this specification, the tensile strength and elongation of the sheet 2 are measured in accordance with the general nonwoven fabric testing method prescribed by “JIS L1913:2010”. A test sample used for the measurement is cut out from the structure sheet 2 or an original thereof. Five test samples in which the length direction matches the length direction of the structure sheet 2 or the original thereof and five test samples in which the length direction matches the width direction of the structure sheet 2 or the original thereof are used in the measurement. The tensile strength and elongation are calculated by averaging the ten measurement values. The test samples are cut out from a zone that includes all of the layers (in this embodiment, the functional layer 4, the intermediate layer 6, the adhesive layer 8, and the reinforcing body 10) included in the sheet 2.

When it is difficult to cut out a test sample in which the length direction matches the width direction of the structure sheet 2 or the original thereof, ten test samples in which the length direction matches the length direction of the structure sheet 2 or the original thereof are used in the measurement. The tensile strength and elongation are calculated by averaging the ten measurement values.

### [Water Vapor Transmittance]

The water vapor transmittance of the structure sheet 2 is preferably 10 g/m²·day or more. After the sheet 2 is adhered to the structure, moisture contained in the structure or moisture existing between the structure and the sheet 2 can be discharged through the sheet 2. The sheet 2 can thus suppress corrosion of metal contained in the structure. The sheet 2 is also suitable for a structure that contains moisture (for example, a structure containing concrete that is not completely dry). The sheet 2 is also suitable for use in rainy weather. From these viewpoints, the water vapor transmittance is more preferably 20 g/m²·day or more, and particularly preferably 25 g/m²·day or more. The water vapor transmittance is preferably 50 g/m²·day or less.

### [Functional Layer]

As is evident from FIG. 3, in this embodiment, the functional layer 4 is positioned uppermost. In other words, when the sheet 2 is adhered to the structure, the functional layer 4 is positioned furthest away from the structure. The functional layer 4 contributes to the functions desired of the sheet 2. These functions include light resistance, weather resistance, heat resistance, abrasion resistance, chemical resistance, water impermeability, moisture impermeability, and moisture permeability, for example. The functional layer 4 can contribute to one or a plurality of functions.

The material of the functional layer 4 is preferably a polymer composition. The functional layer 4 is generally flexible. The sheet 2 having the functional layer 4 is capable of conforming to unevenness on the backing. The polymer composition contains a base polymer. Synthetic resin, synthetic rubber, and natural rubber can be included in the composition as the base polymer. When the base polymer is synthetic resin, the functional layer 4 is also referred to as a “resin layer”.

When the functional layer 4 requires light resistance, a base polymer that is resistant to deterioration by ultraviolet rays is preferable. More specifically, a polymer having a stronger bond energy than that of ultraviolet rays (410 KJ/mol) is preferable. Polymers capable of contributing to the light resistance of the functional layer 4 and the flexibility of the sheet 2 include acrylic resin, acrylic urethane resin, acrylic silicone resin, fluorine resin, flexible epoxy resin, and polybutadiene, for example.

From the viewpoint of light resistance, acrylic silicone resin is a resin that is particularly suitable as the base polymer of the functional layer 4. Acrylic silicone resin has a siloxane bond. Acrylic silicone resin also exhibits superior heat resistance and cold resistance. The product name “COOL LIFE SP Black (CBl) P5-0”, manufactured by Dainichiseika Color & Chemicals Mfg. Co., Ltd., the product name “Belle Earth Elastic Black”, manufactured by Fujikura Kasei Co., Ltd., the product name “ARONBULLCOAT T-1000”, manufactured by Toagosei Co., Ltd., and the product names “ACRYSET EMN-325E” and “UWR EF-008”, manufactured by NIPPON SHOKUBAI CO., LTD., may be cited as specific examples of compositions containing acrylic silicone resin.

When the functional layer 4 requires water impermeability and moisture permeability, the water vapor transmittance of the functional layer 4 is preferably 10 to 50 g/m²·day inclusive. The water vapor transmittance is measured in accordance with the prescriptions in “JIS Z0208”.

The polymer composition of the functional layer 4 can contain additives such as a pigment, a filler, a reinforcing material, and a stain-resistant agent, as required. When the functional layer 4 contains a pigment, the functional layer 4 exhibits a superior cosmetic property. The polymer composition can contain organic pigments and inorganic pigments. The filler may be metal oxide particles such as silica, alumina, and titania, for example. The reinforcing material may be cellulose nanofiber, for example. The content of each of the additives is adjusted in accordance with the function.

An arrow T1 in FIG. 3 represents the thickness of the functional layer 4. From the viewpoint of functionality, the thickness T1 is preferably 10 μm or more, more preferably 30 μm or more, and particularly preferably 50 μm or more. From the viewpoints of conformability, manufacturability, and weight reduction with regard to the sheet 2, the thickness T1 is preferably 500 μm or less, more preferably 300 μm or less, and particularly preferably 150 μm or less. The structure sheet 2 may include two or more functional layers 4. The distribution of the thickness T1 is preferably within a range of +50 μm.

### [Intermediate Layer]

The intermediate layer 6 contributes to the rigidity and so on of the sheet 2. The material of the intermediate layer 6 is preferably a composite material of a polymer and a filler. The polymer of the composite material may be acrylic resin, acrylic silicone resin, fluorine resin, silicone resin, epoxy resin, ethylene-vinyl acetate copolymer, and styrene-butadiene copolymer, for example. The filler of the composite material may be cement, silica, alumina, titanium oxide, calcium carbonate, and carbon black, for example. A preferred composite material is polymer cement. Polymer cement includes a polymer and cement. The polymer is typically acrylic resin. The cement may be Portland cement, alumina cement, or a mixture thereof, for example. Portland cement is preferable. When the material of the intermediate layer 6 is polymer cement, the intermediate layer 6 is also referred to as a “polymer cement cured layer”.

When the intermediate layer 6 contains a polymer and cement, the mass ratio of the polymer to the solid content of the intermediate layer 6 is preferably 10 to 40% inclusive. When this ratio is 10% or more, the intermediate layer 6 exhibits superior adhesiveness to the other layers (the functional layer 4 or the adhesive layer 8). From this viewpoint, the ratio is more preferably 15% or more, and particularly preferably 20% or more. When the ratio is 40% or less, the intermediate layer 6 can contain a sufficient amount of cement. From this viewpoint, the ratio is more preferably 35% or less, and particularly preferably 30% or less.

When the intermediate layer 6 contains a polymer and cement, the mass ratio of the cement to the solid content of the intermediate layer 6 is preferably 20 to 70% inclusive. When this ratio is 20% or more, high tensile strength and low elongation can be achieved in the sheet 2 including the intermediate layer 6. The sheet 2 thus exhibits a superior handling property. From this viewpoint, the ratio is more preferably 30% or more, and particularly preferably 35% or more. When the ratio is 70% or less, the intermediate layer 6 can contain a sufficient amount of the polymer. From this viewpoint, the ratio is more preferably 60% or less, and particularly preferably 55% or less.

When the intermediate layer 6 contains a polymer and cement, the intermediate layer 6 exhibits a superior water vapor transmission property. Thus, when the structure is covered by the sheet 2 including the intermediate layer 6, the metal in the structure is less likely to corrode. The water vapor transmittance of the intermediate layer 6 is preferably 20 to 60 g/m²·day inclusive. The water vapor transmittance is measured in accordance with the prescriptions in “JIS Z0208”.

The intermediate layer 6 can be formed from a mixed solution obtained from a composition containing a polymer and a composition containing cement. When the base material is acrylic resin, the composition containing the polymer is preferably an acrylic emulsion. The acrylic emulsion is obtained by emulsion-polymerizing a monomer. The emulsion polymerization can be performed using an emulsifier. The polymerization can be performed in water containing a surfactant. The monomer is typically an acrylic acid ester or a methacrylic acid ester. The content of the monomer component of the acrylic emulsion is 20 to 100% by mass.

The product name “Spring Coat Brush Mixed Solution”, manufactured by KIKUSUI Chemical Industries Co., Ltd., and the product name “ARONBULLCOAT A450 Base”, manufactured by Toagosei Co., Ltd., can be cited as specific examples of polymer-containing compositions that are suitable for the intermediate layer 6. The product name “Spring Coat Brush Powder”, manufactured by KIKUSUI Chemical Industries Co., Ltd., and the product name “ARONBULLCOAT A450 Setter”, manufactured by Toagosei Co., Ltd., can be cited as specific examples of cement-containing compositions that are suitable for the intermediate layer 6.

An arrow T2 in FIG. 3 represents the thickness of the intermediate layer 6. In this embodiment, as noted above, the reinforcing body 10 is embedded in the intermediate layer 6. Accordingly, the thickness T2 is measured so as to include the reinforcing body 10. From the viewpoint of ease of handling of the sheet 2, the thickness T2 is preferably 100 μm or more, more preferably 300 μm or more, and particularly preferably 500 μm or more. From the viewpoints of conformability, manufacturability, and weight reduction with regard to the sheet 2, the thickness T2 is preferably 1500 μm or less, more preferably 1000 μm or less, and particularly preferably 700 μm or less. The distribution of the thickness T2 is preferably within a range of ±100 μm.

The material of the intermediate layer 6 may be a resin composition or a rubber composition. The structure sheet 2 may include two or more intermediate layers 6. The structure sheet 2 may include two intermediate layers 6 of different materials. The structure sheet 2 may have a layer structure that does not include the intermediate layer 6.

From the viewpoint of the adhesiveness of the intermediate layer 6 to the functional layer 4, the base polymer of the intermediate layer 6 is preferably of the same type as the base polymer of the functional layer 4.

### [Adhesive Layer]

The adhesive layer 8 contacts the backing. The sheet 2 can be adhered to the structure by the adhesive force of the adhesive layer 8. The material of the adhesive layer 8 is preferably an adhesive composition having a polymer as a base material. Suitable polymers for the adhesive composition include acrylic resin, silicone, polyurethane, polyester, natural rubber, and synthetic rubber, for example. Acrylic resin is a particularly preferable polymer for the base material. The product names “ORIBAIN BPS 6574”, “ORIBAIN BPS 6554”, and “ORIBAIN BPS 5565K”, manufactured by TOYOCHEM CO., LTD., can be cited as specific examples of adhesive compositions.

The adhesive composition may contain a curing agent. When the base material is acrylic resin, the curing agent is preferably an isocyanate curing agent. The ratio of the isocyanate curing agent to 100 parts by mass of the acrylic resin is preferably 1.0 parts by mass or more, more preferably 2.0 parts by mass or more, and particularly preferably 2.5 parts by mass or more. This ratio is preferably 10 parts by mass or less, more preferably 8 parts by mass or less, and particularly preferably 7 parts by mass or less.

The adhesive composition can include a tackifier. The tackifier may be a rosin-based tackifier, a terpene-based tackifier, a petroleum resin-based tackifier, or a phenol resin-based tackifier, for example. The ratio of the tackifier to 100 parts by mass of the base polymer is preferably 0.5 parts by mass or more, more preferably 1.0 parts by mass or more, and particularly preferably 1.5 parts by mass or more. This ratio is preferably 15 parts by mass or less, more preferably 10 parts by mass or less, and particularly preferably 7 parts by mass or less. The product names “ESTER GUM H”, “ESTER GUM AA-V”, and “ESTER GUM 105”, manufactured by ARAKAWA CHEMICAL INDUSTRIES, LTD., can be cited as specific examples of tackifiers.

An arrow T3 in FIG. 3 represents the thickness of the adhesive layer 8. From the viewpoint of adhesiveness, the thickness T3 is preferably 20 μm or more, more preferably 40 μm or more, and particularly preferably 50 μm or more. From the viewpoints of manufacturability, weight reduction, and ease of handling with respect to the sheet 2, the thickness T3 is preferably 300 μm or less, more preferably 200 μm or less, and particularly preferably 150 μm or less. The quantity of the adhesive layer 8 is preferably 20 to 250 g/m² inclusive. The structure sheet 2 may include two or more adhesive layers 8.

### [Reinforcing Body (Reinforcement)]

The reinforcing body 10 can contribute to increased tensile strength in the sheet 2. The reinforcing body 10 can also contribute to reduced elongation in the sheet 2. The sheet 2 including the reinforcing body 10 thus exhibits a superior handling property. As noted above, the reinforcing body 10 is embedded in the intermediate layer 6. The reinforcing body 10 may be embedded in the functional layer 4. The reinforcing body 10 may be embedded in the adhesive layer 8. The reinforcing body 10 may be positioned between the functional layer 4 and the intermediate layer 6. The reinforcing body 10 may be positioned between the intermediate layer 6 and the adhesive layer 8. In this specification, the reinforcing body 10 refers to an object that can increase the tensile strength of the sheet 2 in comparison with an imaginary sheet that has an identical layer structure to the layer structure of the sheet 2 except for not including the reinforcing body 10. The layer-form reinforcing body 10 is also referred to as a “reinforcing layer”.

### [Tensile Strength and Elongation of Reinforcing Body]

The tensile strength of the reinforcing body 10 is preferably 5.0 MPa or more. When the tensile strength of the reinforcing body 10 is 5.0 MPa or more, the sheet 2 is less likely to break when tension is applied thereto. The sheet 2 thus has a superior handling property. From this viewpoint, the tensile strength is more preferably 5.5 MPa or more, and particularly preferably 6.0 MPa or more. From the viewpoint of the conformability of the sheet 2, the tensile strength of the reinforcing body 10 is preferably 15.0 MPa or less, more preferably 10.0 MPa or less, and particularly preferably 7.0 MPa or less.

The elongation at break of the reinforcing body 10 is preferably 15.0% or less. When the elongation of the reinforcing body 10 is 15.0% or less, the sheet 2 is less likely to deform when tension is applied thereto. The sheet 2 thus exhibits a superior handling property. From this viewpoint, the elongation of the reinforcing body 10 is more preferably 13.0% or less, and particularly preferably 11.0% or less. From the viewpoint of the conformability of the sheet 2, the elongation of the reinforcing body 10 is preferably 5.0% or more, more preferably 7.0% or more, and particularly preferably 8.5% or more.

The tensile strength and elongation are measured in accordance with the general nonwoven fabric testing method prescribed by “JIS L1913:2010”. A test sample used for the measurement is cut out from the reinforcing body 10 or an original thereof. Five test samples in which the length direction matches the length direction of the reinforcing body 10 or the original thereof and five test samples in which the length direction matches the width direction of the reinforcing body 10 or the original thereof are used in the measurement. The tensile strength and elongation are calculated by averaging the ten measurement values.

A ratio of the surface area of a contour of the reinforcing body 10 to the surface area of the structure sheet 2 when seen from above is preferably 60% or more. When this ratio is 60% or more, the reinforcing body 10 can contribute to the handling property of the sheet 2. From this viewpoint, the ratio is more preferably 70% or more, and particularly preferably 75% or more. The ratio may be 100%. From the viewpoint of conformability at the joint 22, the ratio is preferably 95% or less.

### [Fabric]

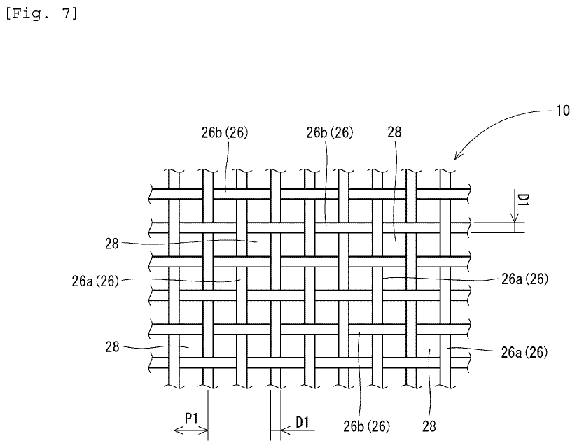

FIG. 7 shows the reinforcing body 10. In the reinforcing body 10, a plurality of warp threads 26a and a plurality of weft threads 26b are woven. In other words, the reinforcing body 10 is a woven fabric (cloth). In this embodiment, the woven fabric has a plain weave structure. The woven fabric is a type of fabric. The fabric reinforcing body 10 can be impregnated with the composition of the intermediate layer 6. This impregnation can contribute to increased tensile strength in the sheet 2. This impregnation can also contribute to reduced elongation in the sheet 2. The reinforcing body 10 may be a fabric other than a woven fabric. Fabrics other than a woven fabric include a knitted fabric (knit) and a cross-welded mesh, for example.

The material of the reinforcing body 10 may be a synthetic resin composition or a metal, for example. Preferred base resins for the synthetic resin composition include polyethylene terephthalate, polyethylene naphthalate, aramid, vinylon, polypropylene, polystyrene, and polyvinylidene fluoride, for example. Preferred metals include aluminum alloy, carbon steel, and alloy steel, for example. By employing the warp threads 26a and weft threads 26b having high tensile strength, a sufficiently high tensile strength can be achieved in the sheet 2. By employing the warp threads 26a and weft threads 26b having low elongation, a sufficiently low elongation can be achieved in the sheet 2.

As is evident from FIG. 7, the reinforcing body 10 includes a large number of holes 28. In this embodiment, each of the holes 28 has a substantially square planar shape. The intermediate layer 6 penetrates the holes 28. This penetration can contribute to increased tensile strength in the sheet 2. This penetration can also contribute to reduced elongation in the sheet 2.

An arrow P1 in FIG. 7 represents the pitch of the threads 26. The pitch P1 is preferably 1.0 to 50 mm inclusive. When the pitch P1 is 1.0 mm or more, a large amount of polymer cement and so on passes through the holes 28 in the reinforcing body 10. The reinforcing body 10 can thus contribute to increased tensile strength and reduced elongation in the sheet 2. From this viewpoint, the pitch P1 is more preferably 1.2 mm or more, and particularly preferably 1.5 mm or more. When the pitch P1 of the reinforcing body 10 is 50 mm or less, the reinforcing body 10 can contribute to increased tensile strength and reduced elongation in the sheet 2. From this viewpoint, the pitch P1 is more preferably 40 mm or less, and particularly preferably 35 mm or less.

An arrow D1 in FIG. 7 represents the thickness of the threads 26. When the thickness D1 of the threads 26 is large, high tensile strength and low elongation can be achieved in the sheet 2. From this viewpoint, the thickness D1 is preferably 0.05 mm or more, more preferably 0.10 mm or more, and particularly preferably 0.15 mm or more. The thickness is preferably 1.0 mm or less.

The structure sheet 2 may include a non-fabric reinforcing body 10. The non-fabric reinforcing body 10 may be formed from nonwoven fabric, long fibers, resin film, or metal foil, for example. The reinforcing body 10 may also be formed from a large number of short fibers dispersed through a composition.

### [Other Layers]

The structure sheet 2 may include another layer positioned on the functional layer 4. The other layer is typically a clear paint layer. The other layer may also be a layer that reinforces or adds a function such as design or heat insulation. The structure sheet 2 may also include a layer positioned between the functional layer 4 and the intermediate layer 6. The structure sheet 2 may also include a layer positioned between the intermediate layer 6 and the adhesive layer 8.

### [Total Thickness]

An arrow Tt in FIG. 3 represents the total thickness of the sheet 2. The total thickness Tt is preferably 200 μm or more, more preferably 400 μm or more, and particularly preferably 500 μm or more. The total thickness Tt is preferably 5.0 mm or less, more preferably 3.0 mm or less, and particularly preferably 1.0 mm or less. The distribution of the total thickness Tt is preferably within a range of +100 μm.

### [Manufacturing Method]

An example of a method for manufacturing the structure sheet 2 will be described below. In this manufacturing method, a first coating material is obtained by mixing the polymer composition of the functional layer 4 with a solvent. A first coating film is obtained by applying the first coating material onto a base film. The solvent is evaporated from the first coating material by heating the first coating film. The base polymer is cured by this heating, whereby the functional layer 4 is obtained.

Next, a second coating material is obtained by mixing the composite material of the intermediate layer 6 with a solvent. A second coating film is obtained by applying the second coating material onto the functional layer 4. The reinforcing body 10 is pressed onto the second coating film. The solvent is evaporated from the second coating material by heating the second coating film. The polymer is cured by this heating, whereby the intermediate layer 6 including the reinforcing body 10 is obtained.

Next, a third coating material is obtained by mixing the adhesive composition of the adhesive layer 8 with a solvent. A third coating film is obtained by applying the third coating material onto a release film. The solvent is evaporated from the third coating material by heating the third coating film, whereby the adhesive layer 8 is obtained.

The adhesive layer 8 is laminated onto the intermediate layer 6. Further, the structure sheet 2 is obtained by peeling the base film away from the functional layer 4 and peeling the release film away from the adhesive layer 8. The release film may remain on the structure sheet 2.

### [Effects]

The structure sheet 2 exhibits superior conformability and can therefore be applied to the roof 12 having a step, as described above. By joining together a plurality of sheets 2, the surface of the roof 12 can be covered by the sheet 2 over a large area. Since the sheet 2 includes the adhesive layer 8, there is no need to apply an adhesive to the roof 12. Since the adhesive layer 8 exhibits superior adhesiveness, the surface of the roof 12 can be covered by the sheet 2 over a large area even when the material of the surface of the roof 12 is a composite material. For example, even when the roof 12 has a surface containing both metal and artificial slate, the surface of the roof 12 can be covered by the sheet 2 over a large area.

The entire surface of the roof 12 may be covered by the sheet 2. In this specification, the surface of the roof 12 refers to the visible surface when the roof 12 is seen from above in a vertical direction. A repair method in which the entire surface of the roof 12 is covered with the single type of sheet 2 is not seen in conventional construction methods.

The sheet 2 is lighter than steel plate, copper plate, galvanized iron plate, and so on. Therefore, even when the surface of the roof 12 is covered by the sheet 2 over a large area, an adverse effect on the earthquake resistance of the building is small. From the viewpoint of earthquake resistance, the density of the sheet 2 is preferably 4.0 g/cm³ or less, more preferably 3.0 g/cm³ or less, and particularly preferably 2.5 g/cm³ or less. This density is much lower than the density of an aluminum-zinc alloy plated steel plate (product name “Galvalume Steel Sheet”) normally used to repair the roof 12.

### [Other Applications]

The sheet 2 can be used to repair or reinforce a structure other than the roof 12. Residential walls, pillars, eaves, fences, gates, doors, parapets, copings, and so on may be cited as structures other than the roof 12. The sheet 2 may also be used on commercial buildings, factories, warehouses, bridges, sewage facilities, railway facilities, tunnels, and so on.

### [Reiterative Repair and Reinforcement]

After the structure (the roof 12 or the like) has been repaired or reinforced using the sheet 2, the sheet 2 or the structure may be damaged or may deteriorate due to aging. By adhering a newly prepared structure sheet 2 to the sheet 2 in the damaged or deteriorated location, repair or reinforcement can be performed reiteratively. By adhering the new sheet 2 so as to overlap the old sheet 2, the value of the structure can be preserved and maintained for a very long period of time. This overlapping adhesion can be achieved using the adhesive force of the adhesive layer 8 of the new sheet 2. In this reiterative repair and reinforcement, there is no need to discard the old sheet 2. Thus, with this reiterative repair and reinforcement, waste generation can be suppressed. The sheet 2 accords with the principles of a circular economy. Even when the low-density sheet 2 is laminated, an adverse effect on the earthquake resistance of the structure is small.

### Second Embodiment

### [Layer Structure]

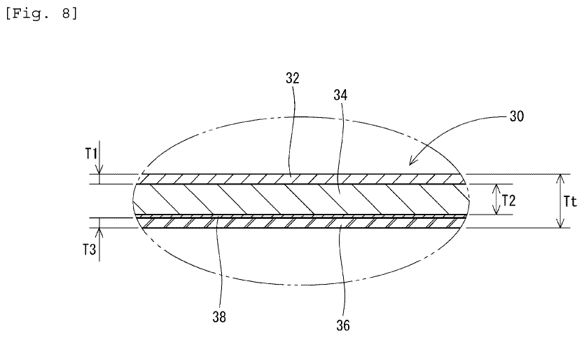

FIG. 8 shows a structure sheet 30 according to another embodiment. The sheet 30 includes a functional layer 32, an intermediate layer 34, an adhesive layer 36, and a reinforcing body 38. Specifications such as the materials and thicknesses of the functional layer 32, the intermediate layer 34, the adhesive layer 36, and the reinforcing body 38 are respectively identical to the specifications of the functional layer 4, the intermediate layer 6, the adhesive layer 8, and the reinforcing body 10 of the structure sheet 2 shown in FIGS. 1 to 3. In the sheet 30, the adhesive layer 36, the reinforcing body 38, the intermediate layer 34, and the functional layer 32 are laminated in that order from the bottom. Likewise with this layer structure, the reinforcing body 38 can contribute to increased tensile strength and reduced elongation in the sheet 30.

### [Tensile Strength and Elongation of Sheet]

The tensile strength of the structure sheet 30 is preferably 5.0 MPa or more. When the tensile strength is 5.0 MPa or more, the sheet 30 is less likely to break when tension is applied thereto. The sheet 30 thus exhibits a superior handling property. From this viewpoint, the tensile strength is more preferably 5.6 MPa or more, and particularly preferably 6.0 MPa or more. From the viewpoint of the conformability of the sheet 30, the tensile strength is preferably 10.0 MPa or less, more preferably 9.5 MPa or less, and particularly preferably 9.0 MPa or less.

The elongation at break of the structure sheet 30 is preferably 15.0% or less. When the elongation is 15.0% or less, the sheet 30 is less likely to deform when tension is applied thereto. The sheet 30 thus exhibits a superior handling property. From this viewpoint, the elongation is more preferably 13.0% or less, and particularly preferably 11.0% or less. From the viewpoint of the conformability of the sheet 30, the elongation is preferably 5.0% or more, more preferably 7.0% or more, and particularly preferably 8.5% or more.

### EXAMPLES

Effects obtained with example structure sheets will be clarified below. The scope of the present specification should not be construed as being limited on the basis of the disclosure in these examples.

### Example 1

A first coating material was obtained by mixing together acrylic silicone resin and a solvent. A first coating film was obtained by applying the first coating material onto a release sheet. A functional layer was obtained by heating the first coating film. The thickness of the functional layer was 100 μm.

A second coating material was obtained by mixing together an acrylic emulsion (the aforementioned product name “Spring Coat Brush Mixed Solution”) and a cement composition (the aforementioned product name “Spring Coat Brush Powder”). A second coating film was obtained by applying the second coating material onto the functional layer. A woven fabric (product name “Cheesecloth #40”, manufactured by SANKO ORIFU) serving as a reinforcing body was pressed onto the second coating film. An intermediate layer including the reinforcing body was obtained by heating the second coating film. The thickness of the intermediate layer was 300 μm. The tensile strength and the elongation at break of the reinforcing body, measured using the methods described above, were 5.20 MPa and 11.0%, respectively.

A third coating material with a gel fraction of 57% was obtained by mixing together 100 parts by mass of an adhesive containing acrylic resin (the aforementioned product name “ORIBAIN BPS 6574”), and 6 parts by mass of an isocyanate curing agent (product name “BHS 8515”, manufactured by TOYOCHEM CO., LTD.). A third coating film was obtained by applying the third coating material onto a release film. An adhesive layer was obtained by heating the third coating film. The thickness of the adhesive layer was 100 μm.

The adhesive layer was laminated onto the intermediate layer. Further, a structure sheet of example 1, having the layer structure shown in FIGS. 1 to 3, was obtained by peeling away the release sheet from the functional layer and peeling away the release film from the adhesive layer.

### Example 2

Apart from using a nonwoven fabric (product name “ELTAS E01012”, manufactured by Asahi Kasei Corp.) as the reinforcing body, a structure sheet of example 2 was obtained in a similar manner to example 1. The tensile strength of the reinforcing body was 0.54 MPa, and the elongation at break was 31.0%.

### Example 3

Apart from using a woven fabric (product name “Cheesecloth #20”, manufactured by SANKO ORIFU) as the reinforcing body, a structure sheet of example 3 was obtained in a similar manner to example 1. The tensile strength of the reinforcing body was 6.15 MPa, and the elongation at break was 10.3%.

### Comparative Example 1

Apart from not providing a reinforcing body, a structure sheet of comparative example 1 was obtained in a similar manner to example 1.

### [Properties of Sheets]

Using the methods described above, the tensile strength and the elongation at break of the structure sheets were measured. The results are shown below on Table 1. Note that the sheet of comparative example 1 stretched greatly at the initial state of the tensile test, making it impossible to measure the tensile strength and elongation objectively.

### [Handling Property]

A worker performed an operation for adhering the structure sheets to a roof. The worker was asked about the handling property. The handling property was ranked according to the following criteria.
A: Extremely good
B: Good
C: Poor
   The results are shown on Table 1 below.

### [Table 1]

TABLE 1
EVALUATION RESULTS

| | EXAMPLE | EXAMPLE | EXAMPLE | COMPARATIVE |
|---|---|---|---|---|
| | 2 | 1 | 3 | EXAMPLE 1 |
| REINFORCING BODY MATERIAL | E01012 | #40 | #20 | — |
| TENSILE STRENGTH (MPa) | | | | |
| OF REINFORCING BODY | | | | |
| VERTICAL DIRECTION | 0.86 | 5.60 | 6.40 | — |
| HORIZONTAL DIRECTION | 0.21 | 4.80 | 5.90 | — |
| AVERAGE | 0.54 | 5.20 | 6.15 | — |
| ELONGATION (%) OF | | | | |
| REINFORCING BODY | | | | |
| VERTICAL DIRECTION | 30.1 | 11.2 | 10.6 | — |
| HORIZONTAL DIRECTION | 31.8 | 10.8 | 9.9 | — |
| AVERAGE | 31.0 | 11.0 | 10.3 | — |
| TENSILE STRENGTH | | | | |
| (MPa) OF SHEET | | | | |
| VERTICAL DIRECTION | 2.66 | 6.10 | 8.20 | — |
| HORIZONTAL DIRECTION | 2.82 | 7.10 | 8.90 | — |
| AVERAGE | 2.74 | 6.60 | 8.55 | — |
| ELONGATION (%) OF SHEET | | | | |
| VERTICAL DIRECTION | 51.3 | 11.0 | 9.8 | — |
| HORIZONTAL DIRECTION | 25.3 | 8.9 | 8.3 | — |
| AVERAGE | 38.3 | 10.0 | 9.1 | — |
| HANDLING PROPERTY | B | A | A | C |

As is evident from Table 1, the structure sheets of the respective examples exhibit superior handling properties. The advantages of these structure sheets are evident from the evaluation results.

### [Disclosed Items]

Preferred embodiments are disclosed by the following items.

### [Item 1]

A structure sheet including a functional layer, an adhesive layer, and a reinforcing body.

### [Item 2]

The structure sheet according to item 1, wherein the reinforcing body is a fabric.

### [Item 3]

The structure sheet according to item 2, wherein the material of the fabric is a synthetic resin composition, and a base resin of the synthetic resin composition is polyethylene terephthalate, polyethylene naphthalate, aramid, vinylon, polypropylene, polystyrene, or polyvinylidene fluoride.

### [Item 4]

The structure sheet according to item 2 or 3, wherein the tensile strength of the fabric, as measured in a tensile test, is 5.0 MPa or more.

### [Item 5]

The structure sheet according to any of items 2 to 4, wherein the elongation of the fabric, as measured in a tensile test, is 15.0% or less.

### [Item 6]

The structure sheet according to any of items 1 to 5, further including an intermediate layer positioned between the functional layer and the adhesive layer, wherein the material of the intermediate layer is a composite material containing a polymer and cement.

### [Item 7]

The structure sheet according to item 6, wherein the adhesive layer, the reinforcing body, the intermediate layer, and the functional layer are laminated in this order.

### [Item 8]

The structure sheet according to item 6, wherein the reinforcing body is embedded in the intermediate layer.

### [Item 9]

The structure sheet according to any of items 1 to 8, wherein the tensile strength, as measured in a tensile test, is 5.0 MPa or more.

### [Item 10]

The structure sheet according to any of items 1 to 9, wherein the elongation, as measured in a tensile test, is 15.0% or less.

### [Item 11]

A method for repairing or reinforcing a structure using a sheet, the method including:
(1) a step of preparing a sheet having a functional layer, an adhesive layer, and a reinforcing body; and
(2) a step of adhering the sheet to a surface of the structure using the adhesive force of the adhesive layer.

### [Item 12]

A method for reiteratively repairing or reinforcing a structure that has been repaired or reinforced using an old sheet, the method including:
(1) a step of preparing a new sheet having a functional layer, an adhesive layer, and a reinforcing body; and
(2) a step of adhering the new sheet to a surface of the old sheet, which is damaged or has deteriorated, using the adhesive force of the adhesive layer.

### INDUSTRIAL APPLICABILITY

The structure sheet described above can be used by being adhered to various objects.

### REFERENCE SIGNS LIST

2 Structure sheet
2a First sheet
2b Second sheet
4 Functional layer
6 Intermediate layer
8 Adhesive layer
10 Reinforcing body
12 Roof
18 Step
22 Joint
24 Step
26 Thread
26a Warp thread
26b Weft thread
28 Hole
30 Structure sheet
32 Functional layer
34 Intermediate layer
36 Adhesive layer
38 Reinforcing body

1. A structure sheet comprising a functional layer, an adhesive layer, and a reinforcing body.

2. The structure sheet according to claim 1, wherein the reinforcing body is a fabric.

3. The structure sheet according to claim 2, wherein the material of the fabric is a synthetic resin composition, and a base resin of the synthetic resin composition is polyethylene terephthalate, polyethylene naphthalate, aramid, vinylon, polypropylene, polystyrene, or polyvinylidene fluoride.

4. The structure sheet according to claim 2, wherein the tensile strength of the fabric, as measured in a tensile test, is 5.0 MPa or more.

5. The structure sheet according to claim 2, wherein the elongation of the fabric, as measured in a tensile test, is 15.0% or less.

6. The structure sheet according to claim 1, further comprising an intermediate layer positioned between the functional layer and the adhesive layer, wherein the material of the intermediate layer is a composite material containing a polymer and cement.

7. The structure sheet according to claim 6, wherein the adhesive layer, the reinforcing body, the intermediate layer, and the functional layer are laminated in this order.

8. The structure sheet according to claim 6, wherein the reinforcing body is embedded in the intermediate layer.

9. The structure sheet according to claim 1, wherein the tensile strength, as measured in a tensile test, is 5.0 MPa or more.

10. The structure sheet according to claim 1, wherein the elongation, as measured in a tensile test, is 15.0% or less.

11. A method for repairing or reinforcing a structure using a sheet, the method comprising:
(1) a step of preparing a sheet having a functional layer, an adhesive layer, and a reinforcing body; and
(2) a step of adhering the sheet to a surface of the structure using the adhesive force of the adhesive layer.

12. A method for reiteratively repairing or reinforcing a structure that has been repaired or reinforced using an old sheet, the method comprising:
(1) a step of preparing a new sheet having a functional layer, an adhesive layer, and a reinforcing body; and
(2) a step of adhering the new sheet to a surface of the old sheet, which is damaged or has deteriorated, using the adhesive force of the adhesive layer.
